(19) United States
(12) Patent Application Publication
(10) Pub. No.: US 2004/0193923 A1
(43) Pub. Date: Sep. 30, 2004

(54) Systems and methods for enterprise security with collaborative peer to peer architecture

(76) Inventors: Frank J. Hammond II, Colorado Springs, CO (US); Frank J. Ricotta JR., Colorado Springs, CO (US); Hans Michael Dykstra, Monument, CO (US); Blake Andrew Williams, Colorado Springs, CO (US); Steven James Carlander, Monument, CO (US); Sarah Williams Gerber, Colorado Springs, CO (US)

Correspondence Address: LATHROP & GAGE LC, 4845 PEARL EAST CIRCLE, SUITE 300, BOULDER, CO, 80301, US

(21) Appl. No.: 10/758,852

(22) Filed: Jan. 16, 2004

Related U.S. Application Data
(60) Provisional application No. 60/440,522, filed on Jan. 16, 2003.
(60) Provisional application No. 60/440,656, filed on Jan. 16, 2003.
(60) Provisional application No. 60/440,503, filed on Jan. 16, 2003.

(51) Int. Cl. G06F 11/30

(52) U.S. Cl. 713/201

(57) ABSTRACT

A system and method protect an electronic network. One or more agents are installed within the electronic network and perform an initial assessment of the electronic network to determine normal activity. The electronic network is then monitored for abnormal activity using the agents, and protected by blocking the abnormal activity using the agents.

### RELATED APPLICATIONS

This application claims priority to: U.S. provisional patent application No. 60/440,522 titled “Exploits in Database Methods and Systems,” filed on 16 Jan. 2003; U.S. provisional patent application No. 60/440,656, titled “Pattern Recognition Systems and Methods,” filed on 16 Jan. 2003; and U.S. provisional patent application No. 60/440,503, titled “Collaborative Peer-To-Peer Architecture,” filed on 16 Jan. 2003, incorporated herein by reference.

This application also claims priority to U.S. Non-provisional patent application Ser. No. 10/687,320, titled “System and Method of Non-Centralized Zero Knowledge Authentication for a Computer Network,” filed on 16 Oct. 2003.

### BACKGROUND

A computer system may contain many components (e.g., individual computers) that are interconnected by an internal network. The computer system may be subject to attack from internal and external sources. For example, the computer system may be attacked when portable media (e.g., a USB drive) is used in by one or more components of the computer system. In another example, the computer system may be attacked when a connection is made (by one or more components) to an external communication device, such as when an individual computer connected to the computer system uses a modem to connect to an information service provider (ISP). In another example, the computer system may be attacked through a permanent connection to the Internet. In another example, the computer system may be attacked through a permanent connection to an internal network (LAN) connected to the Internet. Such attacks may be intended to cripple the targeted computer system either temporarily or permanently, or may instead settle to acquire confidential information, or both. One type of attack may be in the form of a virus: a parasite that travels though network connections (particularly the Internet) and attempts to discover and map encountered computer systems. The parasite may not initially be destructive; in such event it remains undetected since current passive virus detection systems only detect destructive attacks. The parasite may therefore gather critical system information that is sent back to the attacking organization, often as data blended with a normal data stream.

Over time, the parasite's actions allow the attacking organization to build a map of targeted computer systems. Once the map has sufficient information, the attacking organization may launch a more destructive parasite that attacks one or more specific target computer systems at specified times, producing chaos and havoc in the targeted computer systems by generating bad data and possibly shutting down the targeted computer systems.

In another form of attack, an attacker may attempt to gain unauthorized access to a computer system. For example, an attacker may repeatedly attempt to gain access to an individual computer of the computer system by iteratively attempting account and password combinations. In another type of attack, an authorized person may maliciously attempt to corrupt the computer system.

Current protection software only recognizes known parasites, and is therefore ineffective against a new parasite attack until that new parasite is known to the current protection software. Current protection software also operates to detect an attack by monitoring the system for damage; this detection thus occurs after damage is inflicted. Although current protection software may detect certain malicious parasites, computer systems are still vulnerable to mapping parasite attack and other types of attack.

### SUMMARY OF THE INVENTION

In one embodiment, a method protects an electronic network. One or more agents are installed within components of the electronic network. An initial assessment of the electronic network is performed to determine normal activity. The electronic network is monitored for abnormal activity using the agents, and protected by blocking the abnormal activity using the agents.

In another embodiment, a system protects an electronic network. A plurality of agents with the electronic network are grouped into at least one cooperative agent cell having one cell delegate. A communications protocol within each cooperative agent cell, (a) communicates between agents of the cooperative agent cell, and (b) communicates with cell delegates external to the cooperative agent cell. The system has means for determining normal activity levels of the electronic network, means for detecting malicious activity, means for isolating compromised components of the electronic network, means for counter-intelligence to reveal the origin of the malicious activity, means for repairing damage caused by the malicious activity, means for determining vulnerabilities in the current protection provided by the plurality of agents, and means for improving protection to resist future attack on the electronic network.

In another embodiment, a system monitors events. An electronic network collects the events. One or more event correlation engines connected to the electronic network each have a receive event handler for receiving events addressed to the event correlation engine. One or more event correlation modules, each have an event pattern that defines events of interest, and each receives all events received by the event correlation engine. The event correlation module correlates the events of interest.

In another embodiment, a pattern recognition method collects electronic network events. The electronic network events are sampled with one or more event correlation engines. Sampled electronic network events are passed from each event correlation engine to one or more event correlator modules within each event correlation engine. Each of the event correlator modules compares events by sampling the events and determining if any of the events matches an event pattern. If there is a match, a new event is created to announce the match and is passed to the associated event correlation engine for electronic network distribution. Patterns in events are determined using a simulated annealing correlator. If the pattern is determined important, a new event is created to announce the important pattern and passed to the associated event correlation engine for network distribution.

### BRIEF DESCRIPTION OF THE FIGURES

FIG. 1A shows one system for enterprise security with collaborative peer to peer architecture.

FIG. 1B illustrates five agent types and their hierarchy.

FIG. 2 illustrates components of an active agent.

FIG. 3 illustrates three active agents connected to form a cooperative cell.

FIG. 4 illustrates one cooperative agent network with two cooperative agent cells.

FIG. 5 shows an event correlation engine (ECE) that contains a send event handler, a receive event handler and three correlator module slots.

FIG. 6 illustrates one simulated annealing correlator (SAC) module.

### DETAILED DESCRIPTION OF THE FIGURES

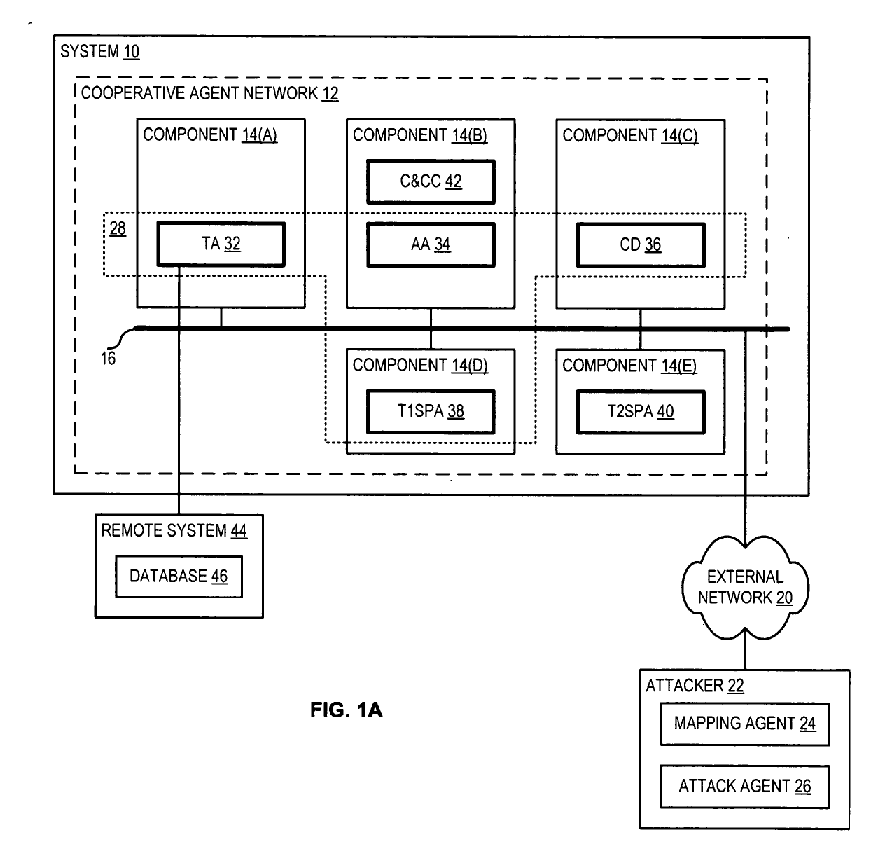

FIG. 1A shows one system for enterprise security with collaborative peer to peer architecture. System 10 is an electronic network that has a plurality of components 14 interconnected by an internal network 16; it also connects to an external network 20 (e.g., Internet). An attacker 22 may launch an attack on system 10 from various points, including through external network 20 that provides access to network 16. Specifically, attacker 22 may attempt to attack system 10 by launching mapping agents 24 and attack agents 26 onto network 20; mapping agents 24 and attack agents 26 then attempt to pass through network 20, to network 16, to attack components 14 of system 10. Attacker 22 may, for example, launch other types of attack on system 10. In one example of another type of attack, a portable media item (e.g., a USB drive, a compact disc, a 3½ inch disk, etc.) may contain mapping agents 24 and/or attack agents 26 such that, when the portable media item is used with one or more components 14 of system 10, mapping agents 24 and/or attach agents 26 attempt access to system 10. In another example of another type of attack, a connection made between one (or more) components 14 and an information service provider (ISP), using a dial-up modem, allows mapping agents 24 and/or attack agents 26 at again attempt access to system 10.

System 10 is protected by a cooperative agent network 12 that includes a telemetry agent (TA) 32, an active agent (AA) 34, a cell delegate (CD) 36, a type-1 super peer agent (T1SPA) 38 and a type-2 super peer agent (T2SPA) 40 (collectively ‘agents’). For optimum security and protection, each component 14 of system 10 has one agent. Components 14(A), 14(B), 14(C), 14(D), 14(E) are thus shown with agents 32, 34, 36, 38, 40, respectively. Agents 32, 34, 36, 38, 40 may each have one or more roles in protecting system 10, and communicate with other agents as necessary.

In the example of FIG. 1A, component 14(E) is a computer (e.g., a server) that runs T2SPA 40. T2SPA 40 is, for example, the first authenticated agent within system 10, which first verifies the integrity of component 14(E) to gain self-authentication. In one example, T2SPA 40 utilizes a fingerprinting or profiling technique to ascertain the component 14(E) has not become compromised while off-line. Additional T2SPA 40 may be added to cooperative agent network 12 as a matter of design choice. Until authorized, functionality of agents 32, 34, 36, 38 and 40 is restricted to fingerprinting their host components 14 and communication for purposes of authentication and authorization. Initially, only T2SPA 40 can authenticate and authorize other agents. Once authenticated and authorized, agents 32, 34, 36 and 38 then assess system 10 to gain knowledge of vulnerabilities and normal activity levels of system 10. Agents 32, 34, 36, 38, 40 may then form one or more cooperative agent cells (e.g., cooperative agent cell 28) within cooperative agent network 12. Each cooperative agent cell performs monitoring and strategic investigation of suspected activity by mapping agents 24 and/or attack agents 26.

Upon detection of activity by mapping agents 24 and/or attack agents 26, or detection of abnormal activity levels, agents 32, 34, 36, 38, 40 may individually or collectively perform one or more of the following steps: (a) isolate the compromised area of system 10; (b) divert mapping attempts to a “honey pot” to give attacker 22 the appearance of success; (c) encode instructions in the data passed back to attacker 22 to reveal the identity and location of attacker 22; (d) counter attack detected mapping agents 24 and attack agents 26; (e) repair damage done by detected mapping agents 24 and attack agents 26; and/or (f) develop and implement strategies to make system 10 more resistant to future attacks.

FIG 1A also shows an optional remote system 44 containing a database 46 that is connected to system 10 via network 16. Remote system 44 is a trusted system, or may be a component 14 of system 10, protected by cooperative agent network 12. Database 46 is initially populated with attack and vulnerability information of system 10 (a) gathered by agents 32, 34, 36, 38, 40 during assessment of system 10, (b) determined and entered manually, and/or (c) gathered from other sources. The information in database 46 is utilized to configure cooperative agent network 12 for optimal protection of system 10. System 44 monitors operation of cooperative agent network 12 and system 10, maintaining configuration and vulnerability information within database 46. As attacks on system 10 occur, system 44 analyses information collected during the attacks, including responses by cooperative agent network 12 to the attack, and stores this information in database 46. System 44 thus collects and stores knowledge of past attacks and vulnerabilities of system 10 in database 46; database 46 is then used to configure cooperative agent network 12, thereby increasing dynamic resistance of system 10 to future attacks.

Component 14(B) also includes a command and control console (C&CC) 42, implemented as a function of active agent 34. C&CC 42 is optional for cooperative agent network 12 and is used to configure and control cooperative network 12, and view reports from cooperative agent network 12. Multiple C&CC 42 may be included in cooperative agent network 12. C&CC 42 communicates with cell delegates 36, T1SPAs 38 and T2SPAs 40.

FIG. 1B illustrates a hierarchy of agents 32, 34, 36, 38, 40 of FIG. 1A. In the depicted embodiment, telemetry agent 32 is the foundation agent type for other agent roles, as shown. Telemetry agent 32 includes core communication and operational structure, but operates only as a reporting agent (i.e., it does not send or receive command and control messages). It collects event information of the component on which it resides (e.g., components 14(A), FIG. 1A) and relays the information to an agent configured for communication (i.e. a cell delegate or a T1SPA) within the cooperative agent cell to which telemetry agent 32 is a member. Telemetry agent 32 may be promoted to become an active agent 34, if desired.

Active agent 34 may be constructed with an innate ability for full peer-to-peer communications, to report data, send command and control messages, and receive command and control messages. Such an active agent 34 may include C&CC 42 functionality. Active agent 34 may also be installed and configured as a member of a cooperative agent cell 28, and thereby operate with other agents (e.g., agents 32, 36, 38 and 40) in cooperative agent network 12.

In the illustrative hierarchy of FIG. 1B, a cell delegate 36 is a specialized type of active agent that is used in a cooperative agent cell 28 and a cooperative agent network 12. Active agent 34 is promoted to cell delegate 36 if it is the first authenticated and authorized agent of cooperative agent cell 28. Cell delegate 36 is responsible for receiving data from other cooperative agent cell members (e.g., agents 32, 34 and 38) and filtering the data (e.g., to remove duplicate or unnecessary entries) before it is sent to a data collection point in cooperative agent network 12, thereby alleviating unnecessary network traffic. Cell delegate 36 is also responsible for disseminating command and control messages received from T1SPA 38 and T2SPA 40 to other members within its cooperative agent cell. Cell delegate 36 also maintains a count of, and reports the health of, other members within its cooperative agent cell. Cell delegate 36 may also create a new cooperative agent cell if the count of members within its cooperative agent cell exceeds a predefined maximum. A new cooperative agent cell may also have a minimum count requirement.

A T1SPA 38 is a super peer agent running on a non-dedicated host computer (i.e., it can run on any component 14 of system 10 that has sufficient resources to support T1SPA 38). In one example, T1SPA 38 performs calculations requiring larger amounts of processing time than available to active agent 34 or cell delegate 36. In one example of operation, T1SPA 38 performs data correlation on data gathered by telemetry agent 32, active agent 34 and cell delegate 36. T1SPA 38 may also provide additional agent authentication and authorization as desired. Active agent 34 and cell delegate 36 may be promoted to T1SPA 38, as necessary, provided that the host component 14 has sufficient resources to support T1SPA 38. T1SPAs 38 are not required within cooperative agent network 12, and are added to increase communication efficiency and performance of cooperative agent network 12.

A T2SPA 40 is the highest ranking agent, possessing more functionality than all other agents. T2SPA 40 runs on a dedicated host computer (e.g., component 14(E), FIG. 1A), and may be denoted as an ‘agent authorization and configuration hub’. T2SPA 40 is not created by promotion of another agent type, and is installed on a dedicated component 14(E) of system 10. At least one T2SPA 40 is required within cooperative agent network 12.

T2SPA 40 may, for example, broadcast a request within system 10 instructing all agents to submit themselves for authentication by T2SPA 40. Agents 32, 34, 36 and 38 are self-organizing, and cooperate to form cooperative agent cells (e.g., cooperative agent cell 28) within a cooperative agent network (e.g., cooperative agent network 12). Each cell has a maximum and minimum number of agents defined by parameters of cooperative agent network 12. In one example, cooperative agent cell 28 includes the maximum number of agents. If an authorized active agent attempts to join cooperative agent cell 28, cell delegate 36 forms a new cooperative agent cell using agents from cooperative agent cell 28 and the active agent attempting to join cooperative agent cell 28. The new active agent cell has at least a minimum number of agents and at least a minimum number of agents remain in cooperative agent cell 28. One active agent in the newly formed cooperative agent cell is promoted to become cell delegate.

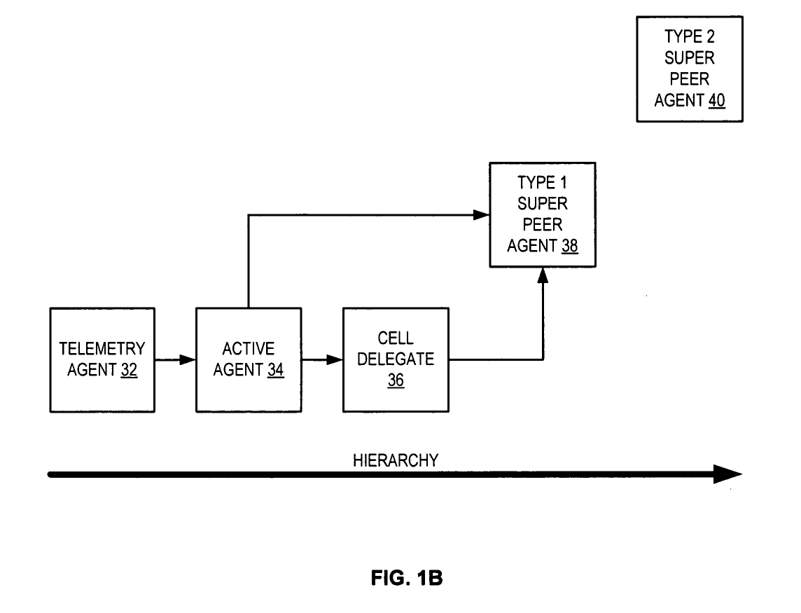

FIG. 2 illustrates components of active agent 34. Active agent 34 includes a micro kernel 202 and a covert communication controller 204. In the example of FIG. 2, micro kernel 202 has two tool housings 206(1), 206(2) that contain portable code segments 208(1) and 208(2), respectively. Micro kernel 202 may have fewer or more tool housings 206 as a matter of design choice. During installation of active agents 34, portable code segments 208 are passed to active agent 34 from T2SPA 40 and contain instructions that provide functionality for active agent 34. In one example of operation, T2SPA 40 sends C&CC functionality within one or more portable code segment 208, such that active agent 34 operates as a command and control consol 42. Active agent 34 may receive one or more portable code segments 208 to add functionality to active agent 34. During use, portable code segments 208 are stored in tool housings 206. Thus, no one active agent 34 contains complete functional capability of an active agent, thereby reducing informational loss should active agent 34 be captured by attacker 22 though use of mapping agents 24 or attack agents 26 (or physical theft of a notebook computer, for example).

Active agent 34 need not run as an ‘active service’ on component 14, FIG. 1. Active agent 34 may be installed on component 14 such that execution cycles of another service or application on component 14 are used by active agents 34, thereby creating no reference of active agent 34 in a process log of component 14. Active agent 34 may also be installed to use “sleep and deploy”, “embed and deploy”, embed and deploy on a specific event” and “timed redeployment” scheduling tactics. By varying the tactic used, predictability and visibility of active agent 34 is reduced. To further decrease the visibility of active agent 34, active agent 34 may communicate with other active agents, thereby creating a confusing trail that prevents easy detection of active agent 34.

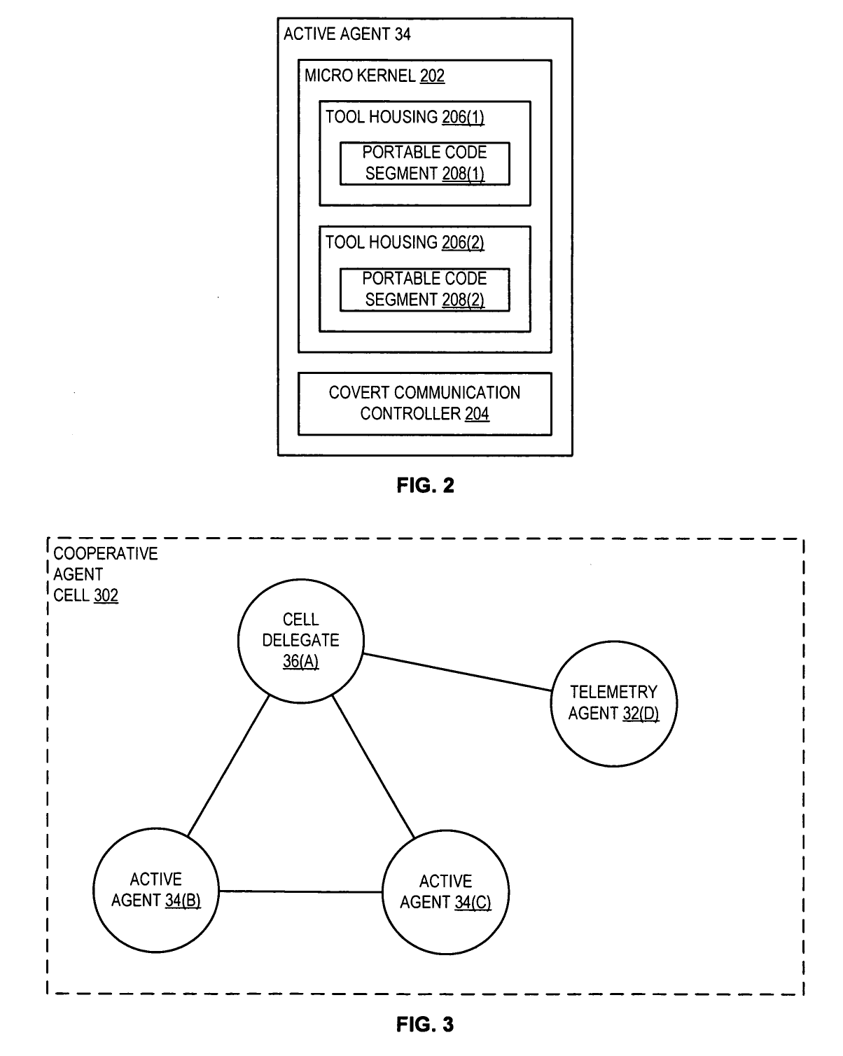

FIG. 3 illustrates one cell delegate 36(A), two active agents 34(B), 34(C) and one telemetry agent 32(D) connected to form a cooperative cell 302. To belong to cooperative agent cell 302, telemetry agent 32, active agents 34(B), 34(C) and cell delegate 36 are first authenticated by T2SPA 40 (and may also be authenticated by any authenticated T1SPA 38 in cooperative agent network 12). In one example, a zero-knowledge authentication protocol is used by type 1 and T2SPAs 40 to authenticate other agents prior to their joining cooperative agent network 12. (U.S. patent application Ser. No. 10/687,320) Other authentication protocols may be used as a matter of design choice. In the example of FIG. 3, a first authenticated active agent 34 to join cooperative agent cell 302 is promoted to cell delegate 36(A). Active agents 34(B), 34(C) communicate with each other and with cell delegate 36(A). Telemetry agent 32(D) only communicates with cell delegate 36(A), in this example. If cooperative agent cell 302 contains a T1SPA 38, telemetry agents 32(D) may also send information to the T1SPA 38.

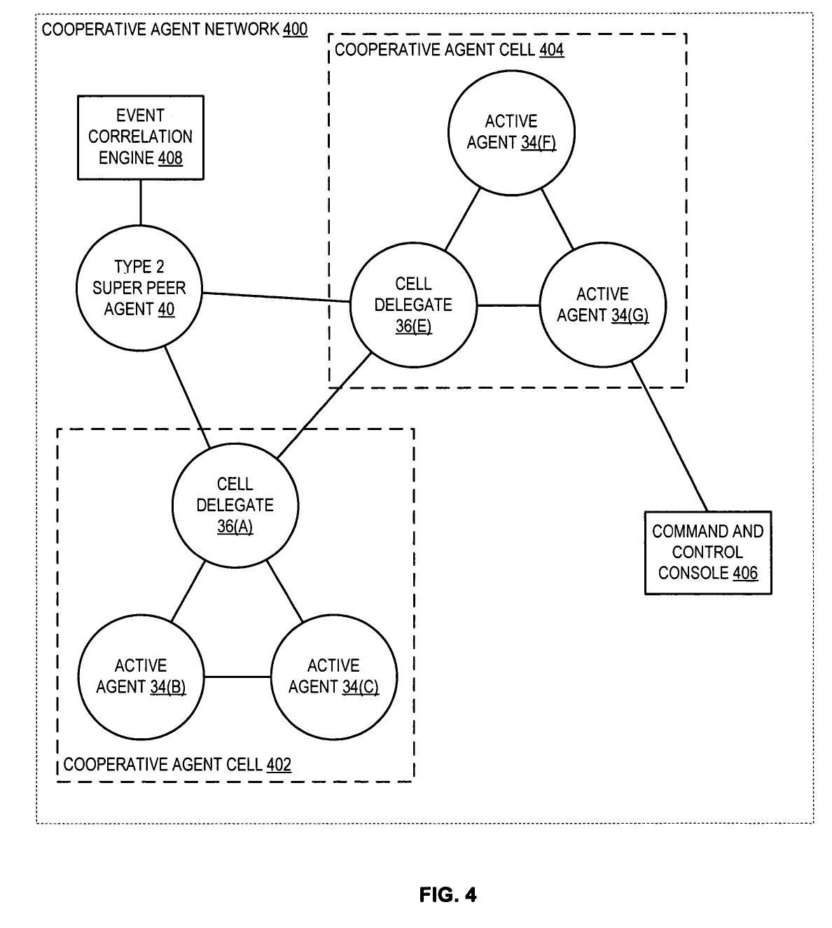

FIG. 4 illustrates one cooperative agent network 400 with one T2SPA 40, two cooperative agent cells 402 and 404, and a C&CC 406. Cooperative agent network 400 may, for example, represent cooperative agent network 12 protecting system 10, FIG. 1. In the example of FIG. 4, cooperative agent cell 402 contains one cell delegate 36(A) and two active agents 34(B), 34(C), and cooperative agent cell 404 contains one cell delegate 36(E) and two active agents 34(F), 34(G). Active agent 34(G) also operates as C&CC 406. C&CC 406 provides an operator interface to cooperative agent network 400, although cooperative agent network 400 can operate autonomously without C&CC 406. Cell delegate 36(A) of cooperative agent cell 402 and cell delegate 36(E) of cooperative agent cell 404 communicate with T2SPA 40. Telemetry agents 32 are not shown within cooperative agent cells 402, 404, for clarity of illustration.

Event information collected by active agents 34(B), 34(C) is sent to cell delegate 36(A). Cell delegate 36(A) filters the event information to remove duplicate and unwanted events, and sends the filtered event information to T2SPA 40. Similarly, event information collected by active agents 34(F), 34(G) is sent to cell delegate 36(E). Cell delegate 36(E) filters the event information to remove duplicate and unwanted events, and sends the filtered event information to T2SPA 40. In this example, T2SPA 40 is the data collection point for cooperative agent network 400. T2SPA 40, in this example, uses an event correlation engine (ECE) 408 to process all received event information. ECE 408 may detect a correlation in the received events that indicates an attempted attack on system 10, for example. ECE 408 informs T2SPA 40 of such a correlation, and T2SPA 40 instructs cooperative agent cells 402, 404 using cell delegates 36(A) and 36(B), respectively, to respond to the attack.

It should be appreciated that additional agents may be added to cooperative agent network 400, forming new cooperative agent cells with new cell delegates as necessary.

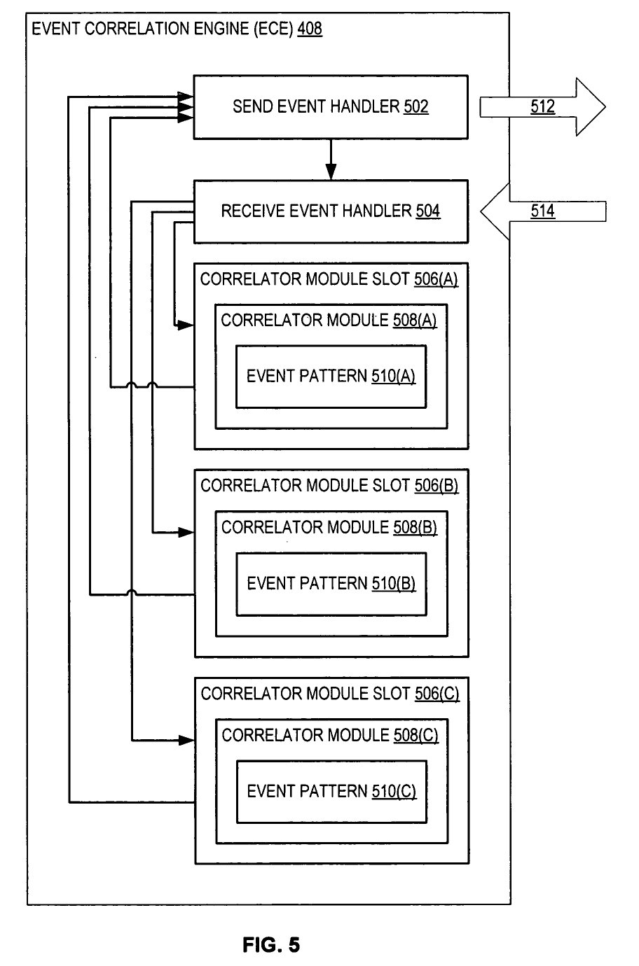

FIG. 5 illustratively shows event correlation engine (ECE) 408 with a send event handler 502, a receive event handler 504 and, in this example, three correlator module slots 506(A), 506(B) and 506(C). In one example, ECE 408 operates within dedicated component 14(E), FIG. 1A. In another example, functionality of part or all of ECE 408 may be included in portable code segments 208 (FIG. 2) and distributed to one or more active agents 34 of cooperative agent network 400.

Correlator module slots 506(A), 506(B) and 506(C) are shown containing correlator modules 508(A), 508(B) and 508(C), respectively. Correlator modules 508 encapsulate intelligence to recognize and report event patterns 510. Correlator modules 508(A), 508(B), 508(C) search for event patterns 510(A), 510(B), 510(C), respectively.

Receive event handler 504 operates to distribute received events 514 to all correlator module slots 506, such that each correlator module 508 receives all received events. Correlator modules 508 may include event filters (not shown) that remove individual events of received events 514 that do not relate to event patterns 510, for example, thereby saving time of correlating the non-related events.

Correlator modules 508 generate and send new events to send event handler 502 upon detection of correlations that match event patterns 510. One example of correlator module 508 is a rule-based correlator. Another example of correlator module 508 is a string-based correlator.

Send event handler 502 outputs the new events as output events 512, and also feeds back these new events to receive handler 504 such that all new events are distributed to all correlation modules 508. Where more than one ECE 408 is included in cooperative agent network 400, these events are distributed to all ECEs 408; correlator modules 508 may thus be loaded into any ECE 408.

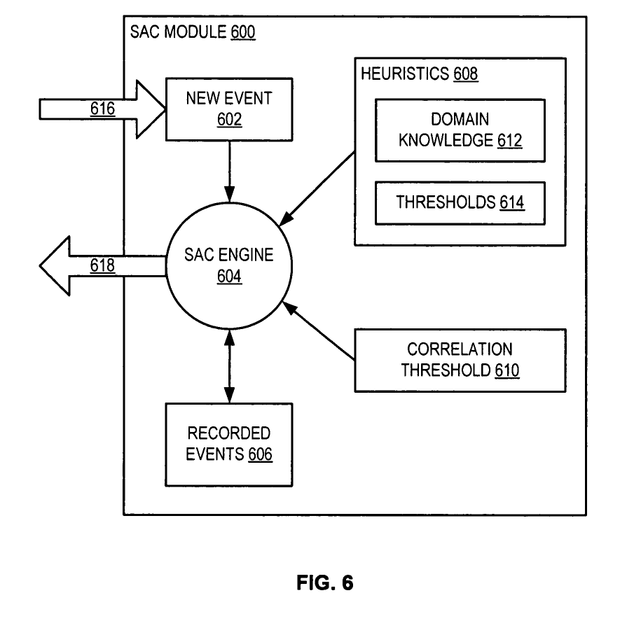

FIG. 6 illustrates one simulated annealing correlator (SAC) module 600 suitable for use as correlator module 508, FIG. 5. SAC module 600 has a SAC engine 604, heuristics 608, and a correlation threshold 610. Heuristics 608 contains domain knowledge 612 and thresholds 614. Heuristics 608 are typically defined manually or generated during initialization of cooperative agent network 400, FIG. 4. Domain knowledge 612 specifies which received events 616 are to be tracked and correlated, how these events are correlated (i.e., the relationship between the events), and the type of report event 618 to generate when a correlation occurs. Thresholds 614 define levels that specify when correlated events are reported. Correlation threshold 610 may, for example be modified by a user (or an automated control system such as a neural network) to controlling event reporting during operation.

SAC module 600 receives events 616 from received event handler 504 of ECE 408, FIG. 5. SAC engine 604 uses heuristics 608 to identify a new event 602 for correlation. SAC engine 604 processes each new event 602 to maximize the similarity of new event 602 to recorded events 606. In one example, SAC engine 604 randomly samples possible matching events and thereby provides a statistical likelihood of finding one or more recorded events 606 that match new event 602.

Heuristics 608 thus control operation of SAC module 600. Other instances of SAC module 600 may be deployed with other heuristics 608 to perform other correlations. Heuristics 608 are thus defined for each instance of SAC module 600. In one example, heuristics 608 are created manually during configuration of cooperative agent network 400. In another example, heuristics 608 are generated and modified by a neural network that monitors operation of cooperative agent network 400.

In one example of operation, cooperative agent network 400, FIG. 4, monitors and protects system 10, FIG. 1. Agents 32, 34, 36, 38 and 40 collect event information of system 10 for processing by ECE 408. ECE 408 includes SAC module 600 that monitors activity level on one or more communication ports of network 16. SAC module 600 determines that activity levels on one communication port are abnormal, and creates and sends an event 618 to C&CC 406, via T2SPA 40, cell delegate 36(E) and active agent 34(G). An operator receives event 618 and determines that a worm is causing a denial of service attack from within network 16. The operator then uses C&CC 406 to command all agents within cooperative agent network 400 to block all communications from the offending server's IP address.

In another example, T2SPA 40 responds automatically to event 618, and instructs cooperative agent cells 402 and 404 to block the offending server's IP address. In another example, cell delegate 36(A) collects event information from active agents 34(B) and 34(C). Cell delegate 36(A) notices high activity at a communication port on network 16 that is monitored by active agent 34(C), instructs active agents 34(B) and 34(C) to block the offending IP address, and further notifies cell delegate 36(E) to do the same. Operational policies configure cooperative agent network 400 to react to abnormal activity levels and attacks in different ways.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method of protecting an electronic network, comprising:
installing one or more agents within components of the electronic network;
performing an initial assessment of the electronic network to determine normal activity;
monitoring the electronic network for abnormal activity using the agents; and
protecting the electronic network by blocking the abnormal activity using the agents.

2. The method of claim 1, wherein the step of installing comprises the step of installing a type 2 super peer agent for authorizing and reauthorizing the agents.

3. The method of claim 1, further comprising logically connecting at least one of the agents into one or more cooperative agent cells.

4. The method of claim 3, wherein the step of installing further comprises:
establishing bidirectional communication protocols for agent communication within the cooperative agent cells;
delegating one or more agents in the cooperative agent cells to have bidirectional communication with another delegated agent; and
establishing bidirectional communication protocols for each delegated agent to communicate with another delegated agent.

5. The method of claim 1, wherein the step of installing further comprises:
broadcasting a request for agents to submit to authentication; and
authenticating submitted agents.

6. The method of claim 3, wherein the step of logically connecting further comprises self-organizing at least one of the agents into each of the cooperative agent cells.

7. The method of claim 4, wherein the step of establishing further comprising communicating via at least one covert communication protocol.

8. The method of claim 1, wherein the step of performing an initial assessment comprises:
mapping systems, communication ports and attached devices of the electronic network; and
establishing normal activity of the systems, communication ports, and attached devices.

9. The method of claim 1, wherein the step of monitoring comprises:
non-destructively intercepting communications on the electronic network;
collecting events from the intercepted communications; and
determining if the events indicate abnormal activity.

10. The method of claim 1, wherein the step of protecting comprises one or more of:
luring a malicious agent that causes abnormal activity into a false appearance of success;
planting instructions on information retrieved by the malicious agent to assist in identifying the origins of the malicious agent;
isolating electronic network components which have been compromised by the malicious agent;
attacking the malicious agent;
formulating a strategy to eliminate recently discovered vulnerabilities in the electronic network;
installing patches to eliminate vulnerabilities in the electronic network;
reassessing the electronic network to detect abnormal operations; and
investigating abnormal operations of the electronic network.

11. The method of claim 3, further comprising promoting one of the agents in each of the cooperative agent cells to a cell delegate.

12. The method of claim 11, further comprising:
promoting a second agent in each of the cooperative agent cells to a type 1 super peer agent;
authenticating new agents with the type 1 super peer agent; and
communicating between the cooperative agent cells and a command and control console via the cell delegate to protect the network from malicious activity.

13. The method of claim 3, the agents and cooperative agent cells being configured for independent and collaborative investigation of the electronic network, isolation of compromised components of the electronic network, and defense of the electronic network.

14. A system for protecting an electronic network, comprising:
a plurality of agents with the electronic network, the agents being grouped into at least one cooperative agent cell having one cell delegate;
a communications protocol within each cooperative agent cell, for (a) communicating between agents of the cooperative agent cell, and (b) communicating with cell delegates external to the cooperative agent cell;
means for determining normal activity levels of the electronic network;
means for detecting malicious activity;
means for isolating compromised components of the electronic network;
means for counter-intelligence to reveal the origin of the malicious activity;
means for repairing damage caused by the malicious activity;
means for determining vulnerabilities in the current protection provided by the plurality of agents; and
means for improving protection to resist future attack on the electronic network.

15. A system for event monitoring, comprising:
an electronic network for collecting events;
one or more event correlation engines, each event correlation engine being connected to the electronic network and having a receive event handler for receiving events addressed to the event correlation engine; and
one or more event correlation modules, each of the event correlation modules having an event pattern that defines events of interest, each of the correlation modules receiving all events received by the event correlation engine, the event correlation module correlating the events of interest.

16. The system of claim 15, wherein the event correlation module is a simulated annealing correlator module.

17. The system of claim 16, the simulated annealing correlator further comprising:
recorded events;
a simulated annealing correlator engine;
heuristics; and
a correlation threshold;
wherein the simulated annealing correlator engine utilizes the heuristics and the correlation threshold to correlate the events received by the event correlation engine with the recorded events, the correlated events being added to the recorded events.

18. A method of pattern recognition, comprising:
collecting electronic network events;
sampling the electronic network events with one or more event correlation engines;
passing sampled electronic network events from each event correlation engine to one or more event correlator modules within each event correlation engine;
comparing events in each of the event correlator modules by sampling the events, determining if any of the events matches an event pattern, and, if there is a match, creating a new event announcing the match and passing the new event to the associated event correlation engine for electronic network distribution; and
determining patterns in events using a simulated annealing correlator, determining if the pattern is important, and, if so, creating a new event announcing the important pattern and passing the new event to the associated event correlation engine for network distribution.

19. The method of claim 18, wherein the step of sampling further comprises sampling all of, or less than all of, the electronic network events.
